(19) United States
(12) Patent Application Publication
(10) Pub. No.: US 2006/0140407 A1
(43) Pub. Date: Jun. 29, 2006

(54) Optical machine locking method and system

(76) Inventor: Richard H. Selinfreund, Clinton, CT (US)

Correspondence Address: KELLEY DRYE & WARREN LLP, TWO STAMFORD PLAZA, 281 TRESSER BOULEVARD, STAMFORD, CT, 06901, US

(21) Appl. No.: 11/271,680

(22) Filed: Nov. 10, 2005

Related U.S. Application Data
(60) Provisional application No. 60/626,750, filed on Nov. 10, 2004.

(51) Int. Cl. H04K 1/00

(52) U.S. Cl. 380/255

(57) ABSTRACT

A method for assuring the authorized nature of encrypted transmissions between a plurality of communicators using a plurality of stand-alone communication processing devices, said method comprising the steps of: a) determining unique characteristics of at least one of said stand-alone communication processing devices involved in said encrypted transmissions between said plurality of communicators; b) comparing said unique characteristics of said at least one of said stand-alone communication processing devices with a roster of unique characteristics associated with authorized stand-alone communication processing devices of authorized communicators; and c) responding to an encrypted message from said at least one of said plurality of communicators only if the stand-alone communication processing device by which such communicator is transmitting an encrypted transmission matches the unique characteristics associated with one or more authorized stand-alone communication processing devices associated with said communicator.

### RELATED APPLICATIONS

This application claims benefit of U.S. Provisional Application No. 60/626,750, filed on Nov. 10, 2004.

### BACKGROUND OF THE INVENTION

There are many systems for concealing electronic data from parties which are not authorized to read or view the data. Public Key is an example of such a “cryptosystem.”

Many cryptosystems employ encryption and decryption keys. In preferred systems, encryption and decryption keys are different. Preferably, the encryption methodology should not reveal the decryption methodology. This is the basis of the RSA public key method.

In RSA:
E_K=Encryption f(x)
D_K=Decryption f(x)
Therefore,
D_K(E_K(P))=P
   E_K can be computed from a public key (x) which is computed from K. X is published, so anyone can encrypt. D_K cannot be deduced without knowledge of the private key K as long as P is large.

Authentication is the key to unlocking a cryptosystem such as RSA. There are multiple problems in authentication, including: (i) the first problem to solve is to make sure the keys are exchanged; (ii) the second problem to solve is to determine if there are eavesdroppers watching the message exchange; and (iii) the third problem to solve is to verify that the encryption was encrypted by a given entity. The RSA algorithm using published public keys has a method to determine authenticity called “Trusted Computing.”

There is an urgent commercial need for a new practical level of electronic security for the Internet and other digital devices. For example, in the past the Microsoft network was broken into by a Dutch hacker named “Dimitri.” Once the hacker gained access, he was able to download administrative passwords and usernames that he could use to break into further areas at Microsoft, which he did four days later. Microsoft and others use a protection algorithm called the Data Encryption Standard (“DES”) to protect information. With THC Hacker tool L0phtCrack, cracking through the DES is relatively simple [see, Quantum Key Distribution: The Future of Security]. The United States government is implementing a new standard above DES called Advanced Encryption Standard (“AES”). The division of the government working on publicly available encryption is the National Institute of Standards and Testing (“NIST”). AES will be a public algorithm that uses the Rijndael standard's cipher formula. The problem is how secure is AES.

### SUMMARY OF THE INVENTION

In an embodiment of this invention, machine locking is used to replace one or more of the RSA requirements of digital signatures [see (http://Raphael.math.uic.edu/˜jeramy/crypt/text/crypt.6.10.txt)].

In yet another embodiment, the concept of quantum encryption and machine locking are wedded together to guarantee authenticity of the sender and the receiver during all transmissions.

NIST is already working on another format to replace AES called Quantum Encryption. Quantum Encryption (“QKD”) uses photon states as the key for encoding information. Invoking Heisenberg's uncertainty principle, one cannot measure the position and the speed of a subatomic particle without altering it during the measurement. Therefore, hackers could not theoretically break into a cryptographic message without altering the message. Using photons to make a cryptographic key is simple to postulate, but has been found to be very difficult to implement in a practical commercial device. For example, one of the first IBM studies in 1989 transmitted a quantum key over only 32 centimeters in open air. Fiber optic transmission can transmit 31 miles, which is not practical for a cell phone. The problem gets worse.

Transmitting a string of photons at 1 million bits per second requires a large photon generator array, telescope and photon detector or particle trap on the other end as a receiver [see, NIST Systems Sets Speed Record For Generation of Quantum Keys for “Unbreakable Encryption,” May 3, 2004]. There is a lot of energy being put into developing a very fast encryption system that, once perceived by an intruder, is then altered. A very fast encryption system based on light would be a significant advance in the state of the art. In the NIST system, the photons transmitted are polarized in one of four directions and must be transmitted during a microburst due to the noise from other photon sources, not the least of which is the sun.

Computer software locking, wherein software is locked to a specific machine, has been known for quite some time [see, e.g., U.S. Pat. No. 5,113,518, to Durst et al., Jul. 3, 1988]. This technique prevents a computer program from being used by an unauthorized computer system. Typically, a software program maps the components of the hardware and then checks that the map matches each time the software runs. This is a very effective tool to make sure that the software is run on only one machine. In several prior art embodiments, machine locking requires that a serial number or call-in number be activated by the user when first installing the software.

In one embodiment of the present invention, a processor, e.g., an optical processor, is mapped in a very large number of places. The speed of creating and accessing this map preferably is in the gigahertz range, but it may be considerably slower. Since each part made by man has its own variability, a unique map may be generated. Such map in conjunction with quantum encryption may be used to greatly enhance security of communications assuring that communicants are indeed authorized communicants for a particular communication or transaction.

Hybrid IC processors capable of high speed are now available. For example, Hybrid IC processors may be purchased from Xan3D Technologies, 10 Al Paul Lane, Merrimack, N.H. 03054. A USB cable tops out at less than 0.5 TGbs, while such Hybrid IC processor systems may allow operation at greater than 200 Gbps. This type of optical processor will work well at peripheral devices attached to a cell phone.

By combining machine locking of the hybrid IC to a communication device, one of ordinary skill in the art would understand the advance that could be made to the “cryptosystem” art. The number of locking points and the speed of the processor allow a significant advance in secured authentic communications.

An object of one embodiment is to provide optical signatures of one or more portable communication devices, cell phones, RFID or smart cards. Such signatures may be determined by a software program that can be run through an optical device. The optical signature is determined and stored. Prior to and/or during transmission of electronic data from one authorized source to a second authorized source, the optical signature of the device is compared for both the sender and the receiver. The optical signature is used to determine the authenticity of both the sender and receiver. The optical component in the communication device provides for the signature. The stored signature is compared to the signature of the device. If there is a match, then the transmission continues. Such system may be configured to:
1) establish and maintain the authenticity of the sender and the receiver during communication;
2) prevent a communication from being played on a second device;
3) prevent unwanted communication from a non-authorized communicator; and/or
4) prevent a communication from being received by a non-authentic device.

### DETAILED DESCRIPTION OF ILLUSTRATIVE EMBODIMENTS

In accordance with one embodiment this invention, a technique is outlined wherein an optical signature of a smart card or a microprocessor of one or more communication devices is determined and stored, and then prior to communicating is stored on the sender and the receiver device. Prior to communication and during communication, the signature is compared and if there is a match between the signatures, the transmission continues.

The signature elements of a communication device may be described in terms of the system components which all have measurable parameters that can be accessed and mapped by mapping software. The signature of the communication device may be defined as values of certain characteristics of the device including, but not limited to: microprocessor access speed, RAM access speed of the microprocessor, and RAM.

In a preferred embodiment, the parameters mapped are parameters that can be rapidly mapped in respect of components of the communication device. For example, an optical microprocessor can be accessed in the gigahertz range.

If the transmission of data is optical, it may be advantageous to operate in the gigahertz range (1 billion bits per second). This may be accomplished, for example, by a pair of printed circuit boards that plug into a standard processor. It could also be accomplished by a microprocessor-based card or some sort of optical intelligent card like a CMOS-based microprocessor [see, Scientific American pp. 81-87 (2004)], such as the currently available hybrid IC processors now available from Xan3D Technologies.

In one embodiment, a practical device which encrypt messages optically between the end user and the transmission is disclosed. This embodiment may include a microprocessor that is serialized and can be addressed optically. The microprocessor may be serialized to the transmission, verifying the authenticity of the transmission. As would be appreciated by those of ordinary skill in the art reading this disclosure, the optical interface may allow software security keys of such a large number and processor speed in that it may greatly exceed non-optical security transmissions available today.

In an embodiment, one takes advantage of the combination of private key software algorithms with machine locking software algorithms to determine the authenticity of the communicating device(s). The software may be resident, for example, on one or multiple components of the device(s) involved, such as an EEPROM device or chip.

### EXAMPLE I

Intel makes a portable −3 gigahertz Pentium 4 processor. A P4 processor with 3 gigahertz with Hyperthread from Intel may be used. In this version, the 105 watts of heat would preferably be removed with a cooling fan. The CMOS chip could provide for an optically variant and serialized device.

Data read rates may approach 9.5 megabytes/second. It may be possible to push the data stream rates up to 22.1 megabytes/s. Then it would be possible to read 1 gigabytes at this rate in 45.2 seconds. This would practically approach quantum level encryption using current smart card technology that is serialized to authenticate sender and receiver and the information being transmitted optically, wireless, or in any other transmission spectrum.

Software is known in the state of the art to allow device locking [see, U.S. Pat. No. 5,113,518].

The optical card may be placed into existing cell phone memory slots for high speed security without a hardware modification. An example of this is a Treo 600.

### EXAMPLE II

Two IC optical microprocessors ordered from Xan3D Technologies may be connected to different Treo 600 cell phones.

The IC chip may be locked to the device and to the communication stream by mapping, for example, one or more of the following components on the chip: passive RF/optical components; silicone GaAS, InP components; and/or multi-stacked Electronic Passives (all associated with the silicon CMOS/Bi-CMOS IP chip).

Processor IC is a state of the art example and may be purchased from several suppliers. Alternatively, the microprocessor may be a conventional microprocessor, for example, purchased from Intel. The processor may be identified as a function of a family as described in U.S. Pat. No. 5,113,518. The identification of the processor may be useful in determining the authenticity of the device. The inherent manufacturing variations in the IC processor and the communication device may allow the software to map the inherent variations in each individual device.

Also asserted in embodiments of the invention is software written to allow:
1) measurement of the signature of a sending and receiving device before transmission of electronic data;
2) measurement of the signatures of sending and receiving devices throughout a communication; and
3) permitting communication only if the measured and stored authentication map (private keys) of all communicating devices and any public keys are authorized.

What is claimed is:

1. A method for assuring the authorized nature of encrypted transmissions between a plurality of communicators using a plurality of stand-alone communication processing devices, said method comprising the steps of:
a) determining unique characteristics of at least one of said stand-alone communication processing devices involved in said encrypted transmissions between said plurality of communicators;
b) comparing said unique characteristics of said at least one of said stand-alone communication processing devices with a roster of unique characteristics associated with authorized stand-alone communication processing devices of authorized communicators; and
c) responding to an encrypted message from said at least one of said plurality of communicators only if the stand-alone communication processing device by which such communicator is transmitting an encrypted transmission matches the unique characteristics associated with one or more authorized stand-alone communication processing devices associated with said communicator.

2. The method of claim 1 wherein one or more of said stand-alone communication processing devices is a cell phone.

3. The method of claim 1 wherein one or more of said stand-alone communication processing devices is a wireless email device.

4. The method of claim 1 wherein one or more of said stand-alone communication processing devices is a smart card.

5. The method of claim 1 wherein one or more of said stand-alone communication processing devices is an RFID.

6. The method of claim 1 wherein one or more of encrypted transmissions is a quantum encrypted transmission.

7. The method of claim 1 wherein at least one of the unique characteristics compared is RAM access speed.

8. The method of claim 1 further comprising the step of validating a private key associated with one or more transmissions.

9. The method of claim 1 wherein the unique characteristics of each of said stand-alone communication processing devices included in said encrypted transmissions are determined in step a).

10. A stand-alone communication device operatively configured to seek unique characteristics of another stand-alone communication processing device to which it communicates and to decrypt transmissions sent from said another stand-alone communication processing device using a public-private key encryption system.

11. The stand-alone communication device of claim 10 wherein the stand-alone communication device is a cell phone.

12. The stand-alone communication device of claim 10 wherein the stand-alone communication device is a smart card.

13. The stand-alone communication device of claim 10 wherein the stand-alone communication device is an RFID.

14. The stand-alone communication device of claim 10 wherein the stand-alone communication device is a wireless email device.
